(19) United States
(12) Patent Application Publication
(10) Pub. No.: US 2002/0092370 A1
(43) Pub. Date: Jul. 18, 2002

(54) Tool positioning apparatus

(76) Inventors: John Pawelek, Rochester Hills, MI (US); Kurt Platz, Troy, MI (US); Roy Jerue, Bloomfield Hills, MI (US); John Boback, (US)

Correspondence Address: Artz & Artz, P.C., Suite 250, 28333 Telegraph Road, Southfield, MI, 48034, US

(21) Appl. No.: 09/761,982

(22) Filed: Jan. 17, 2001

(51) Int. Cl. G01D 21/00

(52) U.S. Cl. 73/866.5; 73/104; 73/150 R; 81/484; 33/626

(57) ABSTRACT

A sensor positioning apparatus comprising a mounting plate, a sensor housing, a sensor assembly pivotally mounted to the sensor housing, and a sensor pivotally mounted within the sensor assembly. The sensor housing includes an upper plate and a base plate connected in a spaced relationship and a central axis. The upper plate is coupled to the mounting plate and the base plate includes a socket adapted to receive a ball joint. The sensor assembly is carried by the housing and comprises a cylindrical body having an opening therein and defining a body axis. The sensor assembly also includes a piston within the body movable between a retracted and an extended position, a ball joint rotatably coupled to the base plate socket, a resilient member for maintaining the body axis substantially coaxial with the central axis, and three contact members for contacting a surface and orienting the sensor assembly normal to the surface. The sensor is pivotally coupled to the piston within the sensor assembly body for orienting the sensor normal to the surface when the piston is in the extended position.

### TECHNICAL FIELD

The present invention relates to a tool positioning apparatus, and more particularly, concerns an assembly for positioning a tool such as a sensor normal to a surface.

### BACKGROUND ART

Many automatic assembly and quality control processes require a tool to be aligned normal to the work piece under consideration. For example, in a vehicle paint quality control process, the paint film thickness is conventionally analyzed using thickness sensors such as ultrasonic measurement sensors or magnetic induction measurement sensors. The sensors are manipulated by an operator to apply the sensor normal to the surface of a vehicle for each paint film thickness reading at each desired location on the vehicle body. At least one reading is acquired at each location on the vehicle body surface to determine the uniformity of the paint film thickness across the entire vehicle body surface. The integrity of the paint film thickness measurements, and the overall quality control of the paint process, requires that the operator position the sensor normal to the point on the vehicle body under consideration as well as at the same plurality of locations for each vehicle body. Errors can be introduced into the quality control process because of the significant involvement required by the operator. Thus, there exists a need for a tool positioning apparatus which repeatedly positions a tool normal to a location on a work piece surface.

U.S. Pat. No. 5,959,211 discloses a method and apparatus for positioning sensors against a non-planar surface. The apparatus includes a moveable fixture which carries a plurality of spring-biased pistons wherein each piston includes a pivotally mounted sensor. Each piston is also linearly moveable with respect to the fixture. Each sensor head is attached by a ball and a socket to the end of the respective piston. In operation, each piston linearly biases the sensor against the work piece surface, and the ball socket and two contact points of the sensor head operate to align the sensor normal to the work piece surface.

The sensor positioning apparatus of U.S. Pat. No. 5,959,211 has several shortcomings. Because the sensor head has only two points of contact with the work piece surface, the sensor does not readily align normal to surfaces having compound contours. In addition, because the sensor is fixed within a sensor head, no mechanism is provided for independently controlling the alignment or proximity of the sensor to the work piece surface. In addition, it has been found that the remotely located sensor head pivot, i.e. the location of the ball and socket joint with respect to the surface, prevents accurate and repeatable sensor alignment with the work piece surface. Moreover, once the sensor head is axially misaligned with its respective piston, no mechanism is provided for realigning the sensor head and piston. This can hinder the ability of the sensor head to align normal to subsequent surface contact points.

It is therefore desirable to provide a method and apparatus for accurately and repeatably aligning a tool normal to each of a plurality of locations on a work piece surface.

### DISCLOSURE OF THE INVENTION

The present invention overcomes the drawbacks of prior art apparatus for positioning sensors against a non-planar surface through the provision of a new and improved tool positioning apparatus. The present tool positioning apparatus includes a sensor positioning apparatus comprising a mounting plate, a sensor housing, a sensor assembly pivotally mounted to the sensor housing, and a sensor pivotally mounted within the sensor assembly. The sensor housing includes an upper plate and a base plate connected in a spaced relationship and defining a central axis. The upper plate is coupled to the mounting plate and the base plate includes a socket adapted to receive a ball joint. The sensor assembly is carried by the housing and comprises a cylindrical body having an opening therein and defining a body axis. The sensor assembly also includes a piston within the body movable between a retracted and an extended position, a ball joint rotatably coupled to the base plate socket, a resilient member for maintaining the body axis substantially coaxial with the central axis, and three contact members for contacting a surface and orienting the sensor assembly normal to the surface. The sensor is pivotally coupled to the piston within the sensor assembly body for orienting the sensor normal to the surface when the piston is in the extended position.

In one aspect of the invention, the sensor positioning apparatus comprises an elongated shaft for coupling the sensor housing to the mounting plate. The shaft defines a shaft axis, and includes a first end and a second end. The first end is coupled to the mounting plate such that the shaft is movable along the shaft axis with respect to the mounting plate. The second end is connected to the sensor housing upper plate. The shaft preferably includes a second resilient member biasing the second end away from the mounting plate.

In another aspect of the invention, the upper plate is coupled to the second end of the shaft by a universal joint within a resilient boot. The resilient boot maintains the shaft axis and the central axis substantially coaxial, and provides an additional pivot point to aid in tool compliance when the apparatus contacts the surface.

A method of positioning a sensor normal to a surface at a desired location for measuring each film thickness at the surface location is also contemplated. The method comprises the steps of providing a sensor positioning apparatus comprising a sensor housing coupled to a movable fixture, a sensor assembly rotatably coupled to the sensor housing and including three contact members for engaging the surface and a piston movable between a retracted and an extended position and, and a sensor pivotally coupled to the sensor assembly piston. The sensor includes a sensor head having at least two surface contact points. The method also includes the step of moving the sensor positioning apparatus toward the surface location until the three contact members engage the surface and orient the sensor assembly normal to the surface. The method continues by moving the piston toward the extended position until the two contact points engage the surface and orient the sensor normal to the surface. The sensor is then operated to measure each film thickness at the location on the surface.

Accordingly, it is an object of the present invention to provide an improved tool positioning apparatus which overcomes the drawbacks associated with known apparatus for positioning sensors normal to a work piece surface. The present invention is advantageous in that it includes at least two axial pivots for aligning the tool normal to the work piece surface. Another advantage of the present invention is that it provides fine control of the tool or sensor position with respect to the work piece surface independent of the positioning assembly in which the tool or sensor is carried.

Other objects and advantages of the invention will become apparent upon reading the following detailed description and appended claims, and upon reference to the accompanying drawings.

### BRIEF DESCRIPTION OF THE DRAWINGS

For a more complete understanding of this invention, reference should be made to the embodiments illustrated in greater detail in the accompanying drawings and described below by way of examples of the invention.

In the drawings:

FIG. 1 is a schematic diagram of two tool positioning apparatus according to one embodiment of the present invention.

FIG. 2 is a top sectional view of a tool housing and a tool assembly of FIG. 1 taken along line 2-2.

FIG. 3 is a sectional view of the tool assembly of FIG. 2 taken along Line 3-3, within the tool assembly articulated normal to an inclined surface.

FIG. 4 is a sectional view of the tool assembly and the base plate taken along line 4-4 of FIG. 2.

FIG. 5 is a schematic diagram of a system for determining paint film thickness at a plurality of locations on a vehicle surface wherein the present invention may be used to advantage.

### DETAILED DESCRIPTION OF THE INVENTION

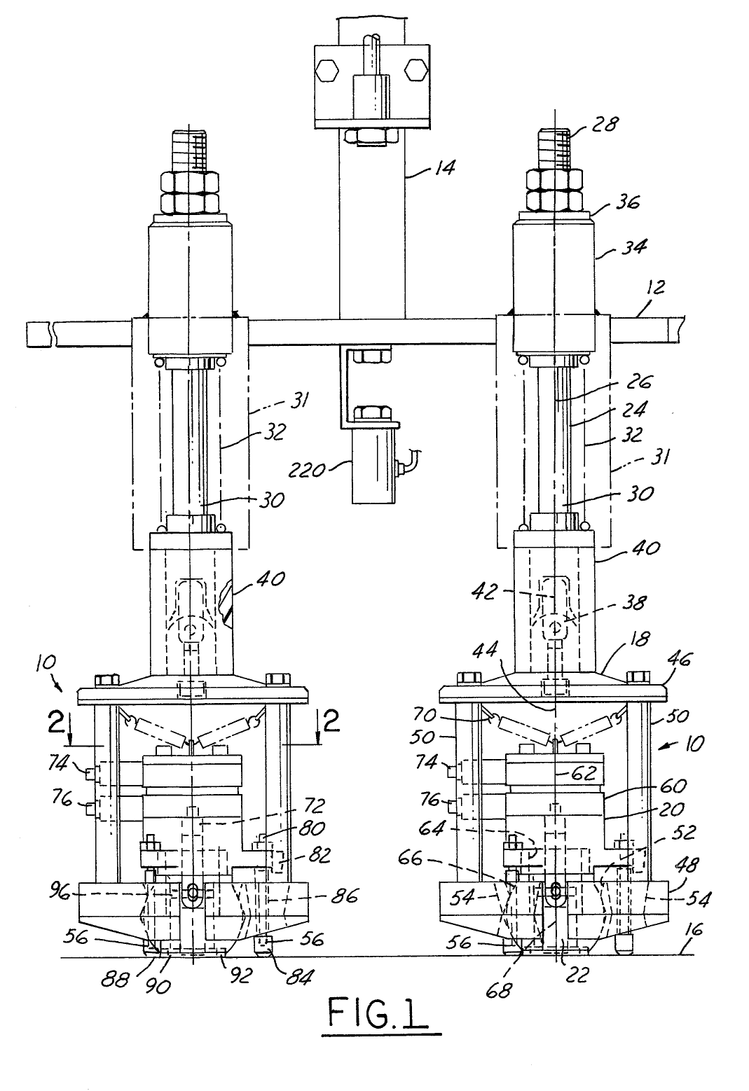

Referring now to FIG. 1, there is shown a schematic diagram of two tool positioning apparatus 10 each of which is fixed to a mounting plate 12 which is preferably connected to an arm of an automated positioning device 14 such as a robot. Each of the tool positioning devices 10 are identical and therefore will be described jointly with reference numerals referring to identical parts of either tool positioning device. The arrangement of the tool positioning devices 10 shown in FIG. 1, is merely illustrative of one example of how the present invention can be used to position a plurality of tools normal to a respective plurality of locations on a surface. In this case, each of the tool positioning devices 10 is shown contacting a surface 16 which may represent, for example, an automotive vehicle body surface.

Each tool positioning device 10 comprises a tool housing 18, a tool assembly 20 carried by the housing 18, and a tool 22 coupled to the tool assembly 20. In broad terms, the arrangement of the tool housing 18, tool assembly 20 and tool 22 provides at least two joints for articulating the tool 22 normal to the work piece surface 16. In particular, the tool assembly 20 is pivotally attached to the tool housing 18 and, as well, the tool 22 is pivotally attached to the tool assembly 20.

In the example shown in FIG. 1, the tool housing 18 is coupled to the mounting plate 12 by an elongated shaft 24. The shaft 24 defines a shaft axis 26 and includes a first end 28 fixedly attached to the mounting plate 12 and a second end 30 which is coupled to the tool housing 18. The second end 30 of the shaft 24 is biased away from the mounting plate 12 by a resilient member such as a coil spring 32. In addition, a bushing 34 and stop 36 couple the shaft 24 to the mounting plate 12 and allow movement of the shaft 24 along the shaft axis 26 with respect to the mounting plate 12. In this way, once the tool positioning device 10 has contacted the surface 16, additional travel of the movement plate 12 towards the surface 16 results in compression of the coil spring 32 and a resulting downward force to maintain the tool positioning device 10 against the surface 16.

As shown in FIG. 1, the present invention also contemplates a third articulation joint for normalizing the tool with respect to the surface 16. In the particular device illustrated, the third articulation joint comprises a universal joint 38. The universal joint 38 is surrounded by a resilient boot 40 to maintain the joint axis 42 coaxial with the shaft axis 26 when the device 10 is not contacting a surface. Under loaded conditions, when an angular force has been exceeded, the boot 40 allows this joint 38 to articulate to aid in orienting the tool 22 normal to the surface. Of course, the third articulation joint may be embodied by other known articulation joints such as a ball and socket arrangement without departing from the scope of the invention.

The tool housing 18 is preferably a cylindrical housing defining a central axis 44 and comprising an upper plate 46 and a base plate 48 connected in a spaced apart relationship by a plurality of posts 50. The upper plate 46, base plate 48 and posts 50 are preferably constructed of a lightweight rigid material such as aluminum. The upper plate 46 is adapted to be coupled to either the mounting plate 12, the second shaft end 30 or one end of the universal joint 38. The base plate 48 includes a socket 52 formed centrally therein for receiving a ball joint.

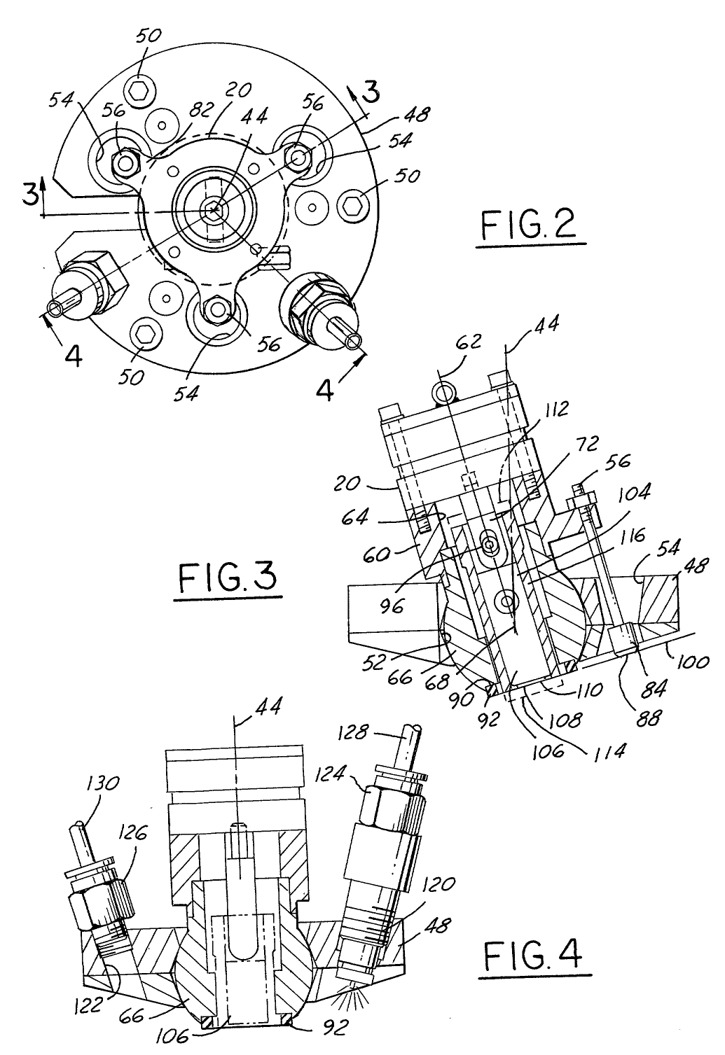

Referring now to FIG. 2, there is shown a top sectional view of the tool housing 18 and tool assembly 20 taken along line 2-2. As shown in FIG. 2, the circular base plate 48 also includes three through-bores 54 equally, radially and circumferentially spaced from the central axis 44 to allow the three contact members 56 associated with the tool assembly 20 to pass through the base plate 48 and contact the desired surface.

Referring again to FIGS. 1 and 2, the tool assembly 20 generally comprises a cylindrical body 60 defining a body axis 62. The body 60 also includes a hollowed-out portion 64 for receiving a tool such as a sensor. One end of the body 60 comprises a ball joint 66 adapted to be rotatably secured to the socket 52 of the base plate 48 thereby allowing the body 60 to articulate about a center point 68. It has been found that locating the tool assembly pivot proximate to the desired surface location under consideration provides advantages in orientating the tool assembly 20 normal to the surface 16. Accordingly, an important aspect of the present invention is the location of primary articulation center 68 with respect to the surface location.

To reduce the friction between the ball joint 66 and socket 52, each preferably comprises a different material. An example of suitable materials for the base plate 48 and for the ball joint 66 is aluminum and a rigid plastic such as Delrin, respectively.

The body 60 of the tool assembly 20 is secured at its other end by a centering mechanism to maintain the body axis 62 substantially coaxial with the central axis 44 when the tool assembly 20 is not in contact with a surface. In the example shown in FIG. 1, the centering mechanism comprises three resilient members such as coil springs 70 connected to the center point of the cylindrical body 60 at one end, and the upper plate 46 or posts 50 of the tool housing 18 at the other end.

The tool assembly 20 also comprises a piston 72 moveable between a retracted position and an extended position along the length of the body axis 62. Preferably, the piston 72 is a pneumatic piston controllable by pneumatic couplings 74, 76 to extend and retract, respectively. The piston 72 is used to move the tool toward and away from the work piece surface once the tool assembly 20 has engaged and orientated normal to the surface 16.

The tool assembly 20 is orientated normal to the work piece surface 16 by three contact members 56 which each comprise a shaft 80 and a contact pad 84. Each shaft 80 is substantially axially aligned with the body axis 62 and is carried by a respective arm 82 which extends transverse to the cylindrical body 60. Each shaft 80 extends through a respective through-bore 54 of the base plate 48 and includes a contact pad 84 comprising a non-marring material such as rubber for contacting the work piece surface 16. Each shaft 80 may also be encased in a protective sleeve 86. The contacting point 88 of each contacting member 56 extends an equal distance from the base plate 48, and together define a plane normal to the body axis 62 of the tool assembly 20. Preferably, the plane defined by the contact point 88 of the contact members 56 lies just below the base 90 of the ball joint 66. The circular rim of the ball joint base 90 may also include a resilient pad 92 for sealingly engaging the circumference of the ball joint base with the work piece surface 16.

The tool 22 is coupled to the piston 72 by a pivot pin 96 to allow the tool 22 to orient normal to the surface 16 when the piston 72 is in the extended position. The pivot 96 allows the tool to align independently of the orientation of the tool assembly 20 resulting from the contact members 56 engaging the work piece surface 16. In this regard, the contact members 56 orient the tool assembly 20 substantially normal to the surface 16 upon contact by all three contact members 56 and thereafter, the pivotally connected tool 22 is allowed to align normal to the surface 16 upon extension of the piston 72 to engage the tool 22 with the surface 16.

In one aspect of the invention, the tool positioning apparatus is particularly well-suited for positioning a sensor normal to a vehicle body surface for determining each paint film thickness at a particular location on the vehicle body surface.

Referring now to FIG. 3, there is shown a sectional view of the tool assembly of FIG. 2 along line 3-3, articulated normal to an inclined surface 100. As seen in FIG. 3, the engagement of the contact members 56 with the inclined surface 100 results in rotation of the ball joint 66 within the socket 52 of the base plate 48 about the center point 68. As a result, the body axis 62 is angularly displaced from the central axis 44 of the tool housing.

In the example shown in FIG. 3, the tool comprises a paint film thickness sensor 104 which is pivotally connected to the piston 72 by a pivot pin 96. The paint film thickness sensor 104 may be a magnetic induction gauge, an optical reflectometry gauge, an ultrasonic sensor or any other sensor for measuring a film thickness. Preferably, the sensor 104 is an ultrasonic sensor such as those available from JSR Ultrasonics of Rochester, N.Y. Such ultrasonic sensors output an ultrasonic signal into the layered paint. At each interface of two adjacent film layers, the signal is reflected and the timing between the transmission and reflection of the signal is used to determine the thickness of each film layer at the particular sensor location on the vehicle body. In this regard, ultrasonic sensors are advantageous in that they simultaneously measure the thickness of each paint film layer at a given location.

The sensor 104 includes a sensor head 106 which includes at least two contact points 108, 110 for contacting the surface 100 and orienting the sensor 104 normal to the surface 100. A preferred embodiment for the sensor head comprises a circular rim. The contact points 108, 110 engage the surface 100 when the piston 72 is moved from the retracted position 112 toward the extended position 114. Preferably, when the piston 72 has reached the extended position 114, the contact points 108, 110 would lie in a plane beyond the surface 100. In this way, the sensor head 106 is ensured to engage the surface 100. The rate and pressure at which such contact occurs is controlled by the rate of flow and pressure of the air delivered to the pneumatic coupling 74 used to extend the pneumatic piston 72. To better enable the contact points 108, 110 to orient the sensor 104 normal to the surface 100, it is desirable to allow some play in the pivot coupling 96 connecting the sensor 104 and piston 72. In this way, the sensor 104 is allowed to articulate within the hollowed-out portion 64 of the tool assembly 60 and orient normal to the surface 100. To reduce the friction between the sensor body and the ball joint 66, a cylindrical bushing 116 surrounds the sensor 104.

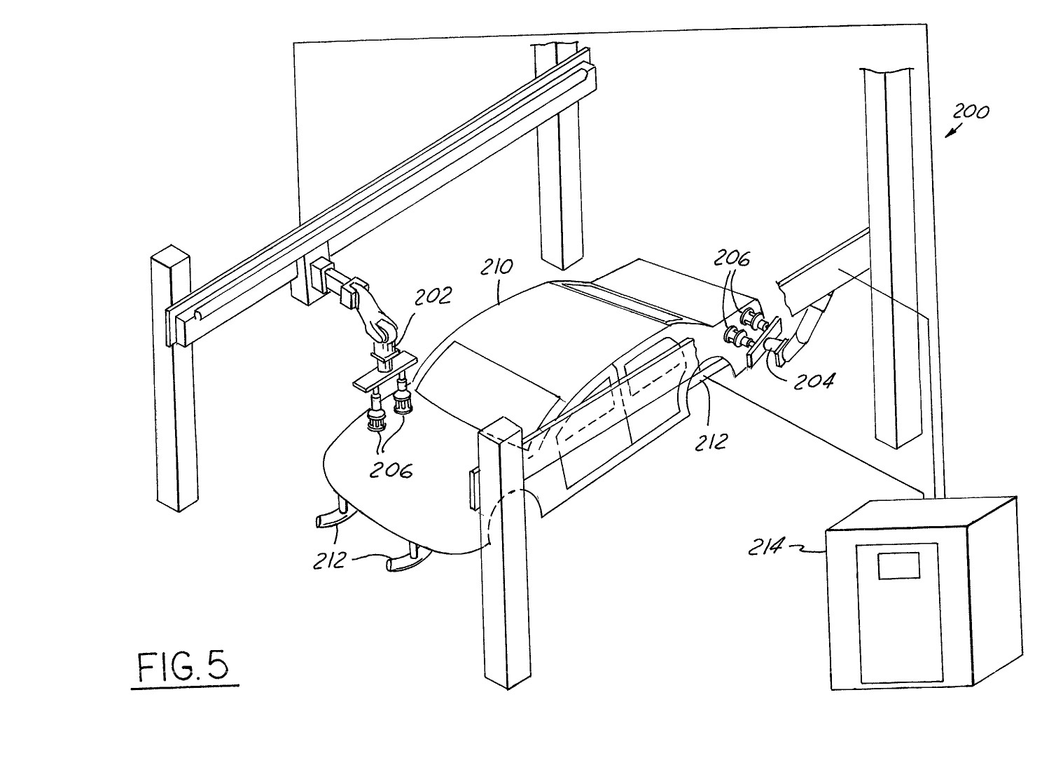

In another aspect of the invention, the tool positioning apparatus includes two fluid nozzles for spraying a first and second fluid on the work piece surface in the area of the sensor contact with the surface. Referring now to FIG. 4, there is shown a sectional view of the tool assembly 20 and the base plate 48 taken along line 4-4 of FIG. 2. The base plate 48 includes a first opening 120 and second opening 122 for receiving respective first fluid nozzle 124 and second fluid nozzle 126. The first fluid nozzle 124 is in fluid communication with a first fluid by way of conduit 128. Similarly, the second fluid nozzle 126 is in fluid communication with a second fluid by way of conduit 130. The first and second fluid nozzles 124, 126 are articulated with respect to the central axis 44 and directed toward the surface location beneath the sensor head.

In operation, the fluid nozzles 124, 126 are used to advantage an ultrasonic sensor-based paint film thickness determination system. The ultrasonic measurement process requires a liquid fluid coupling between the sensor head and the surface to be measured. In this case, the fluid coupling is provided by the first fluid nozzle 124 spraying a liquid such as the deionized water on the surface to be measured as the sensor positioning apparatus approaches proximate the surface to be measured. In this regard, the resilient pad 92 at the base of the ball joint 66 aids in ensuring the fluid coupling between the sensor head and the surface to be measured. Once the sensor is activated and measurements have been taken, the sensor is retracted by the piston and the sensor positioning apparatus is retracted by the automated articulating arm to which it is attached. The second fluid nozzle 126 is preferably activated to provide a shot of compressed gas such as air to the surface location just inspected to disperse the fluid used for liquid coupling the ultrasonic sensor to the surface.

Referring now to FIG. 5, there is shown a schematic diagram of a system for determining paint film thickness at a plurality of locations on a vehicle surface wherein the present invention may be used to advantage. The system 200 comprises an automation cell including at least two automated articulated arms such as robots 202 and 204. An example of a suitable robot is the M-16iLT overhead rail-mounted robot available from Fanuc Robotics of Rochester Hills, Mich. Attached to the mounting plate of each robot is a sensor positioning device according to the present invention. Preferably, two sensor positioning devices 206 are mounted to each robotic arm in a configuration such as shown in FIG. 1.

In operation, a painted vehicle body 210 carried on a vehicle fixture 212 enters the robotic cell and is positioned with respect to the robots 202, 204 by known methods. A controller 214 in operative communication with the robots 202, 204, corresponding sensor positioning devices 206, and vehicle fixture 212 controls the paint film thickness detection process. Once the vehicle body 210 enters and is positioned within the robotic cell, the robots 202 and 204 are moved relative to the body 210 to position the sensor positioning devices 206 at a plurality of locations on the vehicle body 210 for a predetermined period of time at each location.

In a particular example, each robotic arm 202, 204 positions their respective sensor positioning devices 206 just above the desired location and approximately normal to the vehicle body surface at that location. The sensor positioning devices are then moved toward the vehicle body surface to engage the three contact members 56 of each sensor assembly 20 with the vehicle body surface and orient the sensor assembly 20 normal to the surface at that location. At about the same time, when each sensor positioning device is proximate the vehicle body location to be contacted, the first fluid nozzle 124 (FIG. 4) is activated to spray deionized water on the contact surface to aid in establishing a fluid coupling between the surface and the ultrasonic sensor head. For the purpose of improving the accuracy of the paint film thickness measurements, a temperature sensor such as an infrared temperature sensor 220 (FIG. 1) can be activated as well to determine the temperature of the vehicle body under inspection at the particular inspection location. This information can then be used in known ways to improve the accuracy of the paint film thickness determinations.

To ensure proper contact and orientation of the sensor assembly with respect to the vehicle surface, the robotic arms 202, 204 continue moving the mounting plate toward the vehicle surface to compress the compression spring on the connecting shaft of each sensor positioning device. Once the sensor assembly 20 is positioned normal to the vehicle surface, the pneumatic piston 72 is activated to move toward the extended position and thereby force the sensor head against the vehicle body surface. The rate at which the piston extends toward the surface, and the pressure applied to normalize the sensor with respect to the surface are controllable by pneumatic flow control valves and air pressure regulation at the pneumatic couplings 74, 76 (FIG. 1). A circular rim of the sensor head contacts the vehicle body surface and orients the sensor normal to the surface in conjunction with the pivot coupling 96 between the sensor and the piston 72. The ultrasonic sensor is then activated to transmit an ultrasonic signal through the layers of paint at that vehicle body location. The reflective signals indicate interfaces between adjacent layers of paint and can be analyzed by known methods to determine the thickness of each layer of paint film at that vehicle body location. This information can then be used in a quality control process to improve the uniformity of the paint film layers across the entirety of the vehicle body surface.

Once the sensor data has been collected, the pneumatic cylinder is retracted to allow the sensor to return to a home position. Each sensor positioning apparatus is then moved away from the vehicle body surface by their respective robot arm. As each tool positioning apparatus is moving away from the vehicle surface, the second fluid nozzle 126 is activated to provide a shot of air to disperse the water on the painted surface. Once the contact members disengage from the surface, the centering mechanism realigns the sensor assembly 20 with respect to the sensor housing 18. Similarly, the shaft coil spring acts to bias the sensor housing away from the robotic arm mounting plate 20. This process of moving, contacting, measuring and moving away, is then repeated for each desired location on the vehicle body. In practice, a paint film thickness reading can be achieved at a particular location in approximately two seconds, and an entire vehicle can be analyzed in approximately five minutes.

From the foregoing, it can be seen that there has been brought to the art a new and improved tool positioning device which overcomes the drawbacks associated with prior tool positioning devices. While the invention has been described in connection with one or more embodiments, it should be understood that the invention is not limited to those embodiments. For example, more than two tool positioning apparatus may be used per mounting plate depending upon the application and complexity of the surface desired to be analyzed. In addition, the tool positioning apparatus is not limited to sensing or measuring applications. The present invention can be used to orient any tool normal to a surface provided the tool head has two or more contact points. One example of such a tool is a socket for engaging a bolt head for fastening. Accordingly, the invention covers all alternatives, modifications and equivalence, as may be included within the spirit and scope of the appended claims.

What is claimed is:

1. A tool positioning apparatus comprising:
a mounting plate;
a tool housing including an upper plate and a base plate connected in spaced relationship and a central axis, said upper plate coupled to said mounting plate, said base plate including a socket adapted to receive a ball joint;
a tool assembly carried by said housing and comprising a cylindrical body having an opening therein and defining a body axis, a piston within said body movable between a retracted and an extended position, a ball joint rotatably coupled to said base plate socket, a resilient member for maintaining said body axis substantially coaxial with said central axis, and three contact members for contacting a surface and orienting said tool assembly normal to said surface; and
a tool pivotally coupled to said piston within said tool assembly body for orienting said tool normal to said surface when said piston is in the extended position.

2. A tool positioning apparatus according to claim 1 comprising an elongated shaft for coupling said tool housing to said mounting plate, said shaft having a shaft axis, first end and second end, wherein said first end is coupled to said mounting plate such that said shaft is movable along said shaft axis with respect to said mounting plate, and said second end is connected to said tool housing upper plate, and wherein said shaft includes a second resilient member biasing said second end away from said mounting plate.

3. A tool positioning apparatus according to claim 2 wherein said upper plate is coupled to said second end of said shaft by a universal joint within a resilient boot, said resilient boot maintaining said shaft axis and said central axis substantially coaxial.

4. A tool positioning apparatus according to claim 1 wherein said resilient member comprises at least two springs connecting said body to said upper plate to maintain said body axis substantially coaxial with said central axis.

5. A tool positioning apparatus according to claim 1 wherein said tool comprises a sensor having a sensor head including at least two contact points for contacting said surface when said piston is in the extended position and orienting said sensor normal to said surface.

6. A tool positioning apparatus according to claim 5 wherein said sensor is contained within a sleeve.

7. A tool positioning apparatus according to claim 5 wherein said sensor head comprises a circular rim including a resilient pad, wherein said resilient pad contacts said surface when said piston is in the extended position and orients said sensor normal to said surface.

8. A tool positioning apparatus according to claim 5 comprising a first fluid nozzle for spraying a first fluid on said surface.

9. A tool positioning apparatus according to claim 8 wherein said first fluid nozzle is integral with said base plate.

10. A tool positioning apparatus according to claim 8 comprising a second fluid nozzle for spraying a second fluid on said surface.

11. A tool positioning apparatus according to claim 10 wherein said second fluid nozzle is integral with said base plate.

12. A tool positioning apparatus of claim 1 wherein said socket and said ball joint comprise different materials.

13. An apparatus for positioning a plurality of sensors normal to a respective plurality of locations on a surface comprising:
a movable mounting plate and a plurality of sensor positioning apparatus connected to said mounting plate, each sensor positioning apparatus comprising:
an elongated shaft having a shaft axis, first end and second end, said first end coupled to said mounting plate such that said shaft is movable along said shaft axis with respect to said mounting plate, and wherein said shaft includes a resilient member biasing said second end away from said mounting plate;
a cylindrical sensor housing defining a central axis and including an upper plate and a base plate connected in spaced relationship by a plurality of posts, said upper plate coupled to said second end of said shaft, said base plate including a socket adapted to receive a ball joint;
a sensor assembly located within said housing, said sensor assembly comprising a cylindrical body having an opening therein and defining a body axis, a ball joint rotatably coupled to said base plate socket, a piston within said body movable between a retracted and an extended position, a second resilient member connecting said body to said upper plate for maintaining said body axis substantially coaxial with said central axis, and three contact members for contacting said surface and orienting said sensor assembly normal to said surface; and
a sensor pivotally coupled to said piston for orienting said sensor normal to said surface when said piston is in the extended position.

14. An apparatus according to claim 13 wherein said upper plate of each sensor positioning apparatus is coupled to said second end of said shaft by a universal joint within a resilient boot, said resilient boot maintaining said shaft axis and said central axis substantially coaxial.

15. An apparatus according to claim 13 wherein each said sensor comprises a sensor head including at least two contact points for contacting said surface when said piston is in the extended position and orienting said sensor normal to said surface.

16. An apparatus according to claim 13 wherein each said sensor is contained within a bushing.

17. An apparatus according to claim 15 wherein each said sensor head comprises a circular rim and each said contact member includes a resilient pad, wherein each said resilient pad contacts said surface to orient said sensor assembly normal to said surface and each said circular rim contacts said surface when said piston is in the extended position to orient said sensor normal to said surface.

18. An apparatus according to claim 13 wherein each sensor positioning apparatus comprises a first fluid nozzle for spraying a first fluid on said surface.

19. An apparatus according to claim 18 wherein each sensor positioning apparatus comprises a second fluid nozzle for spraying a second fluid on said surface.

20. An apparatus according to claim 19 wherein each of said first and second fluid nozzles are integral with each respective base plate.

21. A method of positioning a tool normal to a surface comprising:
providing a tool positioning apparatus comprising a tool housing coupled to a movable fixture, a tool assembly rotatably coupled to said tool housing and including three contact members for engaging said surface and a piston movable between a retracted and an extended position and, and a tool pivotally coupled to said tool assembly piston, said tool including a tool head having at least two surface contact points;
moving said tool positioning apparatus toward said surface until said three contact members engage said surface and orient said tool assembly normal to said surface; and
moving said piston toward said extended position until said at least two contact points engage said surface and orient said tool normal to said surface.

22. A method according to claim 21 comprising the step of moving said piston toward said retracted position and, thereafter, moving said tool positioning apparatus away from said surface.

23. A method according to claim 21 wherein said tool housing is biased away from and movable with respect to said movable fixture and wherein the step of moving said tool positioning apparatus includes the step of continuing moving said tool positioning apparatus toward said surface after each of said three contact members engage said surface.

24. A method according to claim 21 wherein the step of moving said piston includes the step of moving said piston toward said extended position at a predetermined rate.

25. A method of positioning a sensor normal to a surface at a desired location for measuring each film thickness at said surface location, the method comprising the steps of:
providing a sensor positioning apparatus comprising a sensor housing coupled to a movable fixture, a sensor assembly rotatably coupled to said sensor housing and including three contact members for engaging said surface and a piston movable between a retracted and an extended position and, and a sensor pivotally coupled to said sensor assembly piston, said sensor including a sensor head having at least two surface contact points;
moving said sensor positioning apparatus toward said surface location until said three contact members engage said surface and orient said sensor assembly normal to said surface;
moving said piston toward said extended position until said at least two contact points engage said surface and orient said sensor normal to said surface; and
operating said sensor to measure each film thickness at said location on said surface.

26. A method according to claim 25 comprising the step of spraying a first fluid from a first fluid nozzle onto said surface in the area of said location to provide a fluid coupling between said sensor and said surface.

27. A method according to claim 26 comprising the step of spraying a second fluid from a second fluid nozzle onto said surface in the area of said location to disperse said first fluid.

28. A method according to claim 27 wherein said first fluid is de-ionized water and said second fluid is air.

29. A method according to claim 25 wherein said sensor housing is biased away from and movable with respect to said movable fixture and wherein the step of moving said sensor positioning apparatus includes the step of continuing moving said sensor positioning apparatus toward said surface after each of said three contact members engage said surface to orient said sensor assembly normal to said surface.

30. A method according to claim 25 wherein the step of moving said piston includes the step of moving said piston toward said extended position at a predetermined rate.

31. A method according to claim 25 comprising moving said piston toward said retracted position and, thereafter, moving said sensor positioning apparatus away from said surface.

32. A method according to claim 25 comprising, after said at least two contact points engage said surface, moving said piston toward said extended position at a predetermined pressure to orient said sensor normal to said surface.

33. A system for determining a thickness of each paint film at a plurality of locations on a vehicle surface comprising:
a robotic cell including at least one robot, each of said robot including a mounting plate and a sensor positioning apparatus attached to each mounting plate;
a vehicle fixture for supporting and positioning said vehicle within said robotic cell; and
a controller in operative communication with said at least two robots and said vehicle fixture for positioning each said sensor positioning apparatus at a predetermined plurality of vehicle surface locations and for receiving sensor signals indicative of each paint film thickness at each said respective plurality of vehicle surface locations,
wherein each said sensor positioning apparatus comprises:
a sensor housing defining a central axis and including an upper plate and a base plate connected in spaced relationship, said upper plate coupled to said mounting plate, said base plate including a socket adapted to receive a ball joint;
a sensor assembly located within said housing and comprising a cylindrical body having an opening therein and defining a body axis, a piston within said body movable between a retracted and an extended position, a ball joint rotatably coupled to said base plate socket, a resilient member for maintaining said body axis substantially coaxial with said central axis, and three contact members for contacting a surface and orienting said sensor assembly normal to said surface; and
a sensor pivotally coupled to said piston for orienting said sensor normal to said surface when said piston is in the extended position.

34. A system according to claim 33 wherein each sensor positioning apparatus comprises an elongated shaft for coupling said sensor housing to said mounting plate, said shaft having a shaft axis, first end and second end, wherein said first end is coupled to said mounting plate such that said shaft is movable along said shaft axis with respect to said mounting plate, and said second end is connected to said sensor housing upper plate, and wherein said shaft includes a second resilient member biasing said second end away from said mounting plate.

35. A system according to claim 34 wherein each said upper plate is coupled to said second end of said shaft by a universal joint within a resilient boot, said resilient boot maintaining said shaft axis and said central axis substantially coaxial.

36. A system according to claim 33 wherein each sensor comprises a sensor head including at least two contact points for contacting said surface when said piston is in the extended position and orienting said sensor normal to said surface.

37. A system according to claim 33 wherein each sensor head comprises a circular rim including a resilient pad, wherein said resilient pad contacts said surface when said piston is in the extended position and orients said sensor normal to said surface.

38. A system according to claim 33 wherein each sensor positioning apparatus comprises a first fluid nozzle for spraying a first fluid on said surface.

39. A system according to claim 38 wherein each sensor positioning apparatus comprises a second fluid nozzle for spraying a second fluid on said surface.
